(19) United States
(12) Patent Application Publication
(10) Pub. No.: US 2008/0027941 A1
(43) Pub. Date: Jan. 31, 2008

(54) Method and System For Providing A Searchable Virtual Information Center

(75) Inventors: Andrea L Greggo-McManus, Gardiner, NY (US); Geoffrey S. Reilly, Middletown, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/460,833

(22) Filed: Jul. 28, 2006

(51) Int. Cl. G06F 17/30

(52) U.S. Cl. 707/10

(57) ABSTRACT

A searchable virtual information center comprising a master node accessible by a user and one or more information nodes coupled to the master node. The information nodes may be either intermediate nodes or leaf nodes containing searchable documentation. A search request received from a user at the master node, containing search criteria for searching the documentation, is transmitted from the master node to the information nodes. Upon performing the search, the information nodes transmit the search results back to the master node, which collects the results and presents them to the user in the form of a list of information nodes reporting search results. The user may select one of the nodes from the list to obtain a display of search results for that node.

### CROSS-REFERENCE TO RELATED APPLICATION

This application is related to the commonly owned, concurrently filed application of the same inventors, Ser. No. ______, entitled “Method and System for Providing a Viewable Virtual Information Center” (docket POU920040259US1) and incorporated herein by reference.

### BACKGROUND OF THE INVENTION

1. Field of the Invention

This invention relates to a method and system for providing a searchable virtual information center, as described more fully below.

2. Description of the Related Art

The current Eclipse help system (WebSphere help system) functions by packaging one or more documentation plug-ins within the help system. The help system reads the packaged plug-ins by accessing one primary XML (Extensible Markup Language) navigation file, which in turn may call other XML navigation files and HTML content topic files. This is described in such references as the online publication written by Arthur Barr, entitled “Documenting your project using the Eclipse help system”, available on the IBM developerWorks Web site.

FIG. 1 shows an example of a conventional IBM WebSphere help system information center as displayed from a browser. (IBM and WebSphere are trademarks of IBM Corporation.) The Web Sphere help system is based upon tools distributed by the Eclipse Foundation, as described in more detail on the latter organization's Web site, and is therefore alternatively referred to herein as the Eclipse help system. A user of a WebSphere help system launches a URL (uniform resource locator) in a browser such as Microsoft Internet Explorer, Netscape Navigator, or Mozilla. (Microsoft and Internet Explorer are trademarks of Microsoft Corporation; Netscape and Navigator are trademarks of; Mozilla is a trademark of the Mozilla Organization.) The browser displays an online information center 100 with two frames: a left-hand navigation frame 102 and a right-hand main viewing frame 104. The navigation frame 102 displays the results of an XML navigation call in an expandable and contractible fashion. As shown in the figure, information is arranged hierarchically, with product headings 106, one or more topic headings 108 under each product heading 106, and one or more subtopic headings 110 under each topic heading 108. Selecting an entry corresponding to a particular subtopic heading 110 in the navigation frame 104 (e.g., “subtopic b” under “Topic A” under “Product C information”) displays the resulting HTML content in the main frame 104.

FIG. 2 shows the basic architecture of a documentation plug-in 200. As shown in the figure, the plug-in 200 consists of a plug-in file 202 (plugin.xml), one or more table-of-contents (TOC) files 204 (toc.xml), and a documentation file 206 (doc.zip); the last of these consisting of a plurality of individual HTML documentation files (not separately shown) that have been zipped into a single ZIP file. As noted above, the plug-in file 202 functions as a master navigation file referencing one or more TOC files 204. In an example taken from the above-identified Barr publication, a typical plug-in file 202 referencing a single TOC file 204 might look as follows:

Listing 1. Plug-in Definition

```
<plugin name=“Sample Documentation Plug-in”
id=“com.ibm.sample.doc”
    version=“1.0.0” provider-name=“IBM”>
    <extension point=“org.eclipse.help.toc”>
      <toc file=“toc.xml” primary=“true” />
    </extension>
</plugin>
```

If a given plug-in file 202 were to reference multiple TOC files 204, the latter files would be differently named. Each table-of-contents file 204 in turn references one or more documentation files (existing as separate HTML files or zipped into a single ZIP file 206 as shown.) In the same example taken from the above-identified Barr publication, a typical TOC file 204 might look as follows:

Listing 2. Table-of-Contents Definition

```
<toc label=“Sample Documentation”>
    <topic label=“My Section” href=“mySection.html”>
      <topic label=“Foo” href=“foo.html”/>
      <topic label=“Bar” href=“bar.html”/>
    </topic>
</toc>
```

A single documentation plug-in 200 can exist in a WebSphere help system as shown in FIG. 2, or multiple documentation plug-ins 200 linked by a master XML file (not shown) can co-exist in a single local information center as shown in FIG. 3. However, the larger the documentation plug-ins grow, the more unmanageable the information center becomes.

The current help system is generally used in a standalone fashion, meaning that the product A vendor creates product documentation for single or multiple releases of product A and releases it into an individual help system URL or a common help system URL on the Web. Customers of product A can go to the product Web site and access the release-specific product documentation for the product. However, when considering a production environment where the intent is to integrate multiple products into a solution or system-level enterprise, the need to be able to integrate individual product documentation information centers into one solution-based information center becomes apparent.

The current WebSphere help system is generally well-suited for creating a common information center vehicle for product documentation. Additionally, the consistent usage of the help system creates the foundation for integration. However, as each product release is promoted independently and on different schedules, recreating or adding a document plug-in into a solution-based information center becomes unmanageable.

### BRIEF SUMMARY OF THE INVENTION

One aspect of this invention, which is the subject of the concurrently filed application referenced above, introduces the ability to create a virtual information center comprised of multiple standalone information centers. Using points of integration and separation, a virtual information center is created, which has the ability to expand and shrink the scope of the pool of information available to end users.

More particularly, this aspect of the present invention contemplates a viewable virtual information center comprising a master node accessible by a user and one or more information nodes coupled to the master node. Content descriptions describing the documentation from the information nodes are collected at the master node and combined into an integrated content description, which is presented to the user from the master node. One or more of the information nodes may be intermediate nodes having one or more lower-level nodes, in which case the content descriptions for the lower-level nodes are collected through the intermediate nodes. Each information node corresponds to a documentation plug-in; an integrated documentation plug-in is generated from the content descriptions collected from the information nodes. In response to user selection of a portion of the integrated content description corresponding to one of the information nodes, a separate display is generated of the portion corresponding to that node.

This aspect of the invention addresses performance and functionality problems in Eclipse-based information centers, which are brought about by overloading the information centers with too much documentation. Additionally, this aspect of the invention addresses the problem of information center isolation by allowing multiple information sets to be seamlessly associated with a single information center, although they are disparate entities in nature.

As further described below, this aspect of the invention uses two ideas, point of separation and point of integration, to seamlessly provide the look and feel of a single information center. This aspect of the invention builds virtual integration by providing a series of linked information centers, or nodes. This approach allows customers to go to one master information center, and from there access any documentation they need, without needing to look in isolated islands of information.

Another aspect of this invention, which is the subject matter of the present application, addresses the search functionality and behavior while searching in Eclipse-based information centers implementing the method and system described above. In particular, it relates to how to perform manageable search routines in large-scale information centers, which as currently implemented are not readily searchable with the existing search function.

This other aspect of the present invention contemplates a searchable virtual information center comprising, as before, a master node accessible by a user and a plurality of information nodes coupled to the master node. In accordance with this aspect of the invention, a search request received from a user at the master node, containing search criteria for searching the documentation, is transmitted from the master node to the information nodes. Upon performing the search, the information nodes transmit the search results back to the master node, which collects the results and presents them to the user in the form of a list of information nodes reporting search results. The user may select one of the nodes from the list to obtain a display of search results for that node.

In this other aspect of the present invention, search criteria entered into the master node, or point of integration, are disseminated to the hierarchical information nodes, where the search is run. In a preferred embodiment, only those nodes with search hits turn up in the resulting search results, but rather than display all of the returned hits, only the nodes are returned. Selecting a node with search hits returns the actual search hits for that node. This aspect of the invention enables searches to be performed across a series of virtually linked information centers and to return the search hits to a local interface using the method and system described above.

The present invention may be implemented as hardware, as software, or as a combination of hardware and software. A software implementation may comprise a program storage device of one or more volumes using semiconductor, magnetic, optical or other storage technology. The program storage device is readable by a machine and tangibly embodies logic in the form of a program of instructions executable by the machine to perform method steps of the invention. A computing infrastructure for performing the method steps of the invention may be deployed by integrating into a computing system computer-readable code that in combination with the computing system is capable of performing the method steps of the invention.

### BRIEF DESCRIPTION OF THE SEVERAL VIEWS OF THE DRAWING(S

FIG. 1 shows an example of a WebSphere help system (Eclipse-based help) information center as displayed from a browser.

FIG. 2 shows the basic components of a document plug-in for the WebSphere help system (Eclipse-based help).

FIG. 3 shows multiple document plug-ins as would be expressed in a single WebSphere help system instance to integrate separate content.

FIG. 4 displays the navigation a user would see when using the WebSphere help system with the point of integration and point of separation implemented.

FIGS. 5A and 5B show virtual information centers from the standpoint of system topology.

FIG. 6 displays the concepts of the point of integration, which is the presentation layer and not content specific, and the points of separation, which are the unique content nodes.

FIGS. 7A and 7B display the logic that applies in the point of integration in order to allow the presentation.

FIG. 8 shows a conceptual image of what a WebSphere user might see in the navigation frame the master node.

FIG. 9 shows a conceptual image of what a WebSphere user might see as a point of separation from the master node.

FIG. 10A shows the flow of search data in a virtual information center in which all of the information nodes are leaf nodes.

FIG. 10B shows the flow of search data in a virtual information center in which at least one of the information nodes is an intermediate node referencing lower-level nodes.

FIG. 11 shows the steps performed when searching for content in a virtual information center.

FIG. 12 shows a search box in the help system on a user's machine.

FIG. 13 shows the format for displaying search results returned from a node selected by a user.

### DETAILED DESCRIPTION OF THE INVENTION

The following terms are used in the description that follows:

Point of integration. A point of integration, or master node, is a master framework where logical groupings of information nodes are declared and presented to end users. In reality, the navigation presented is a simple presentation and placeholder to actual content. The point of integration can be thought of as an information center hub, or a publication hub, and represents a home base for the categorization, or hierarchy of information. Typically, the point of integration would reside on a server system, which a user on a client system would access using a Web client (i.e., a browser) such as Microsoft Internet Explorer or Netscape Navigator. The virtual information center of the present invention may be thought as a hierarchical tree, with the master node, or point of integration, constituting the root node and the various information nodes to be described constituting the lower-level nodes of the tree.

Information node. An information node is a unique documentation plug-in representing an information center. The point-of-integration/point-of-separation concept of the present invention is based on a series of linked information nodes. Typically (but not necessarily), the information nodes would reside on individual server systems that are separate from the master node and are coupled to the master node (as well as to each other) using any suitable technology. Each information node has a unique identifier, which is read by the master node, or point of integration, as described below.

Point of separation. A point of separation is the exact point where the virtual linking ends and you have arrived at an actual information center with content. The points of separation are the leaf nodes of the system hierarchy.

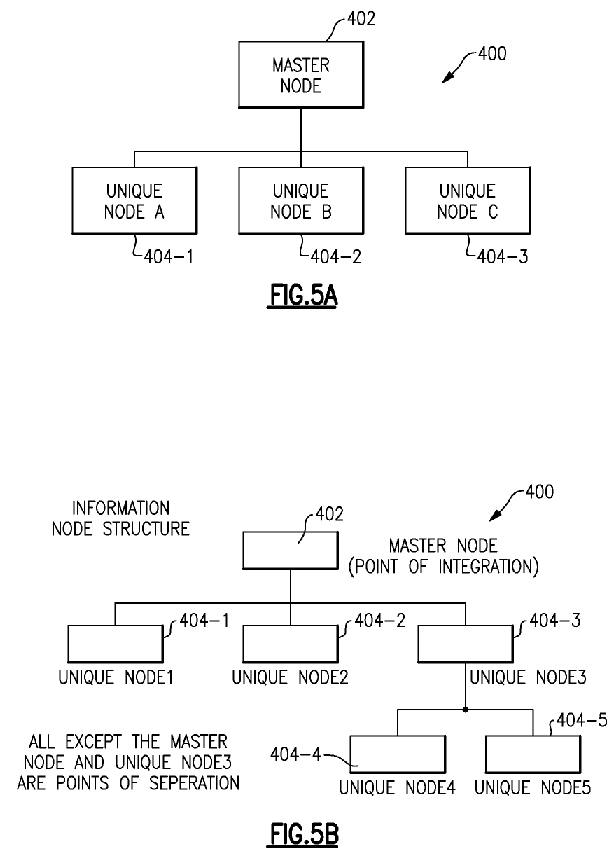

FIG. 4 shows this concept from the standpoint of a user. As shown in this figure, a virtual information center 400 comprises a master node 402, a first-level information nodes 404.1, two of which are shown, and second-level information nodes 404.2, two of which are also shown (these information nodes being collectively referred to herein as nodes 404). Each of the first-level nodes 404.1 corresponds to a particular major category of documentation served by the master node 402 (“Information A”, “Information B”, etc.), while each of the second-level nodes 404.2 corresponds to a particular subcategory of documentation served by the first-level node 404.1 referencing the second-level node 404.2 (“Topic A”, “Topic B”, etc.). Second-level nodes 404.1 are thus the leaf nodes, or points of separation, of the hierarchy, while first-lcvel nodes 404.1 are intermediate nodes of the hierarchy. A node hierarchy is not restricted to two levels of information nodes, however, and a different number of levels may be used if desired.

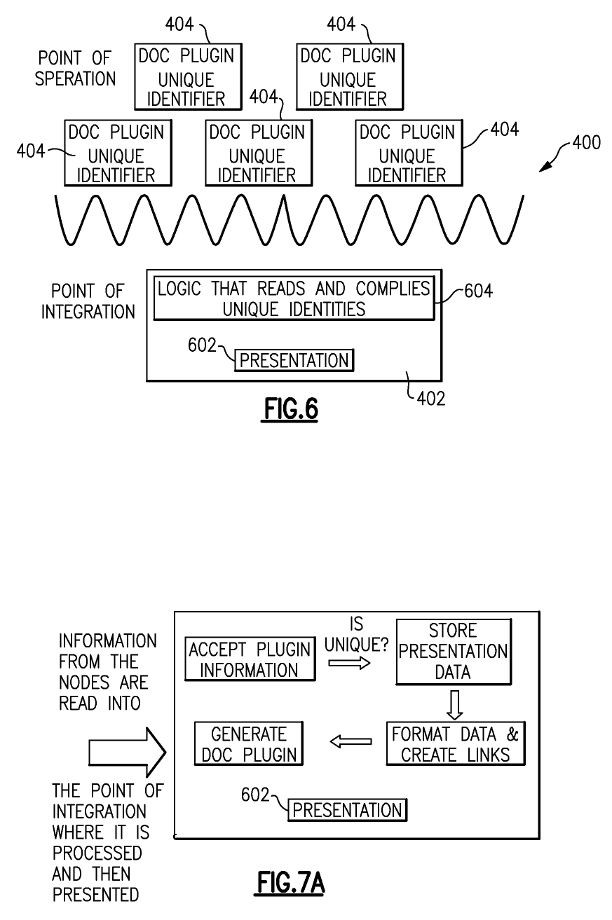

FIGS. 5A and 5B show the concept of a virtual information center 400 from the standpoint of system topology. FIG. 5A shows a single master node 402 and a set of unique information nodes 404-1 to 404-3 (these information nodes also being collectively referred to herein as nodes 404). In this particular example, nodes 404-1, 404-2 and 404-3—i.e., all of the nodes except the master node 402—are what are referred to herein as points of separation, since they contain documentation and do not point to any other nodes. They are thus the leaf nodes, while master node 402 is the root node in the hierarchy of the virtual information center 400.

As already shown in FIG. 4, a virtual information center 400 may have one or more intermediate information nodes 400 referencing one or more lower-level information nodes 400 (which may be either leaf nodes or intermediate nodes referencing still lower-level nodes). FIG. 5B shows a single master node 402 and a set of unique nodes 404-1 to 404-5. In this particular example, nodes 404-1, 404-2 are points of separation as in the FIG. 5A example, however, node 404-3 is now an intermediate node referencing lower-level nodes 404-4 and 404-5, so that nodes 404-1, 404-2, 404-4 and 404-5 now make up the point-of-separation nodes.

The master node or point of integration 402 is a virtual master repository for all of the unique nodes 404. Referring to FIG. 6, the master node 402 contains a presentation layer 602, as well as logic 604 including an XML parser that reads and compiles the unique identifiers and other data received from the nodes 404. Each unique node 404 that is also a point of separation (nodes 404-1, 404-2, 404-3 and 404-4 in FIG. 4) will launch actual content. Those that are not considered points of separation (node 404-3 in FIG. 4) will be a virtual stepping stone for content.

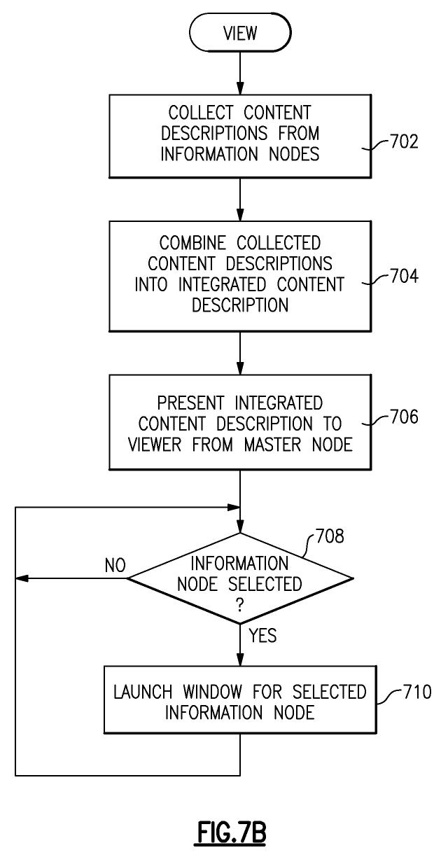

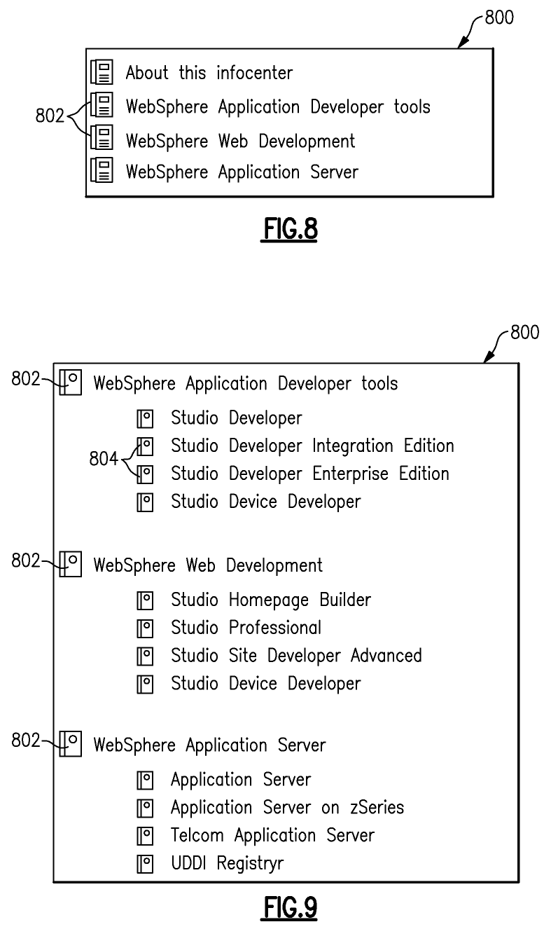

Referring now also to FIGS. 7A and 7B, the steps to achieve this in the framework of the WebSphere help system documentation plug-in architecture, which are performed when a user launches the information center (400 in FIG. 5A) via the master node (402 in FIG. 5A), are as follows:
1. The master node 402 collects content descriptions from the information nodes 400 by calling the XML parser 604 (FIG. 6), which is targeted (FIG. 7B, step 702). The parser 604 reads the unique identifiers for the information nodes 404. The parser 604 reads the plugin.xml file (the structural declarative file for any documentation plug-in) for two attributes: plugin id and plugin name.
2. The data is returned to the master node 402 and formatted to combine the collected content descriptions into an integrated content description (step 704). The formatting includes the dynamic production of a documentation plug-in, essentially the structure that would have existed had all the documentation resided at the master node 402, which is presented to the user from the master node 402 (step 706). This creates the virtual content that a user sees when launching the information center 400 via the master node 402.
3. The virtual linking via the point of integration 402 has been created and the illusion of one information center 400 with numerous product documentation information hosted is now available.
4. Selecting any navigation option in the left hand menu corresponding to a leaf node 404 (step 708) creates a point of separation which launches the information node 404, and as a result the content, in a new browser window (step 710).

These steps may be performed only at the master node 402 or, alternatively, similar steps may be performed done at each other node (the “stepping stones”) between the master node 402 and a point of separation 404, with the results being rolled up to the master node 402.

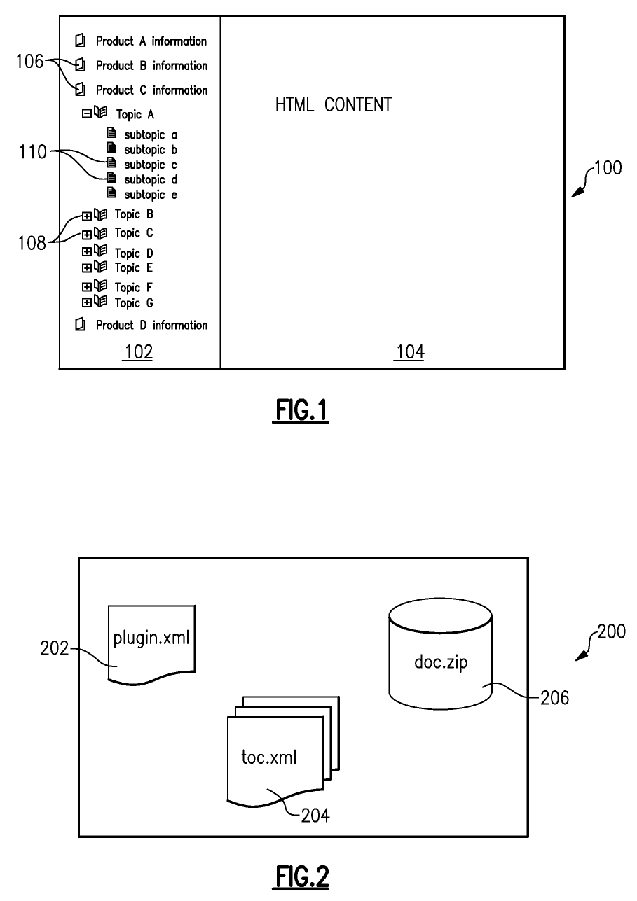

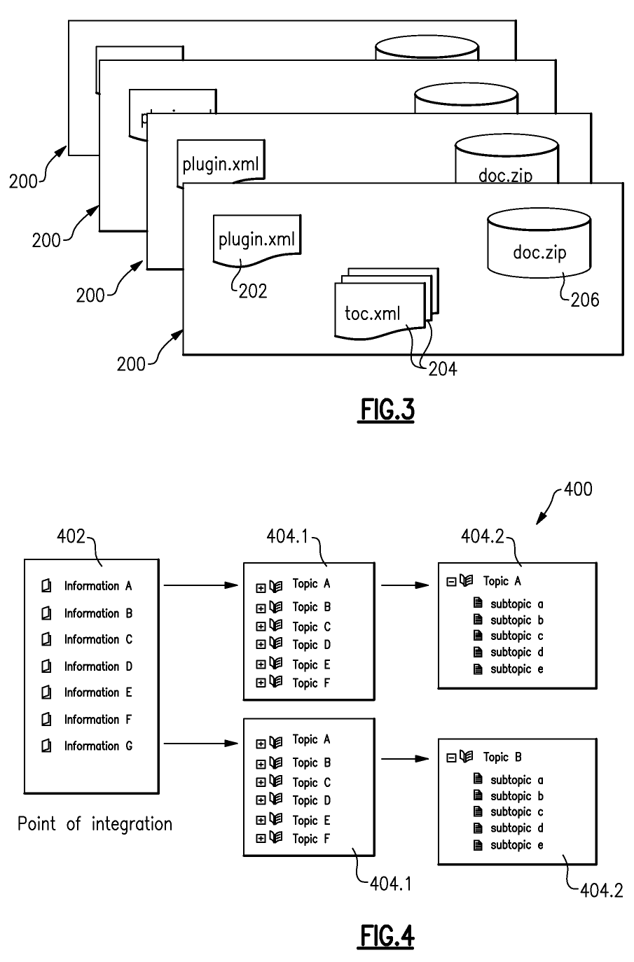

FIG. 8 shows an example of what a WebSphere user would see in a navigation frame 800 similar to the navigation frame 102 of FIG. 1 when launching the master information center of the present invention. The entries 802 all appear to be in the same information center.

Referring now also to FIG. 9, when the user clicks on a particular entry 802, for example, the entry 802 labeled “WebSpherc Application Developer tools”, the book will expand to list the products 804 (corresponding to information nodes 404) that fall under that category. Similarly, the entries 802 labeled “WebSphere Web Development” and “WebSphere Application Server” can be expanded to list the products 804 (corresponding to information nodes 404) associated with each. Selecting any one of the highlighted products 804 will result in viewable information topics in a new browser window, since we have “drilled down” to a level corresponding to a point-of-separation node 404. This is the point of separation referred to above.

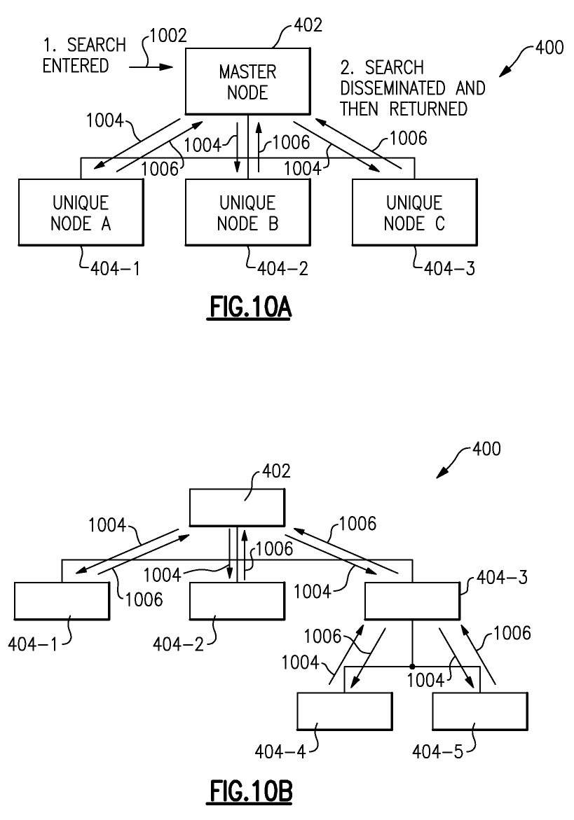

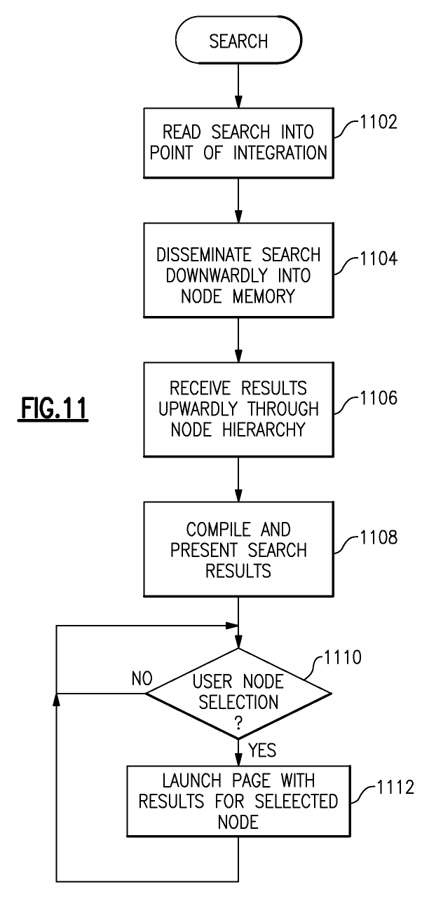

FIGS. 10A-10B and 11 show how a search for content in the virtual information center 400 is performed from the master node 402. FIG. 10A shows the flow of search data in the virtual information center 400 of FIG. 5A in which all of the information nodes are leaf nodes, while FIG. 10B shows the flow of search data in the virtual information center 400 of FIG. 5B in which at least one of the information nodes (node 404-3) is an intermediate node referencing lower-level nodes (nodes 404-4 and 404-5). FIG. 11 shows the steps performed.

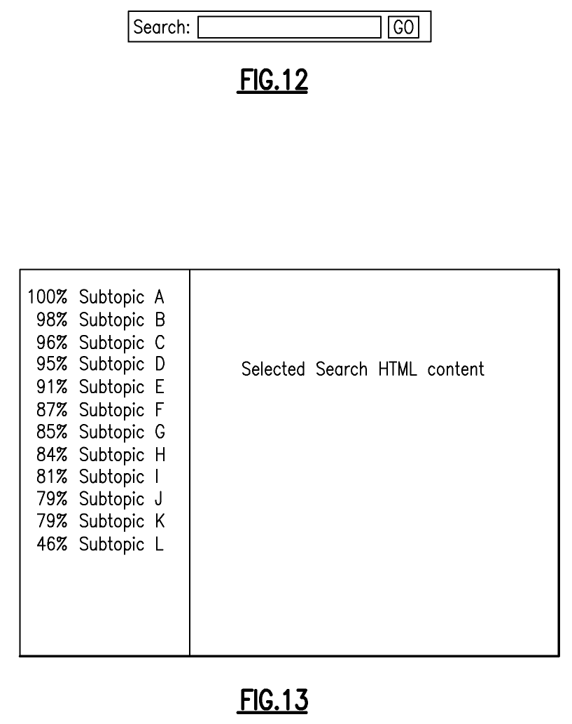

Referring now to FIGS. 10A-10B and 11, searching across the virtual information center 400 is performed as follows:
1. The master node 402, which is already aware of its environment including all of the points of separation, receives from a user accessing the node 402 a search request containing search criteria, as shown by arrow 1002 in FIG. 10A (step 1102). The user makes such a search request by entering it into a search box (FIG. 12) or the like, just as the user would do it in a conventional system
2. The search criteria are fed to each unique node 404, as shown by arrows 1004 in FIGS. 10A and 10B (step 1104). This is done by having the master node 402 forward the search criteria to each unique node 404 that it directly references. If a particular recipient node 404 is an intermediate node referencing one or more lower-level nodes 404, the recipient node 404 forwards the search criteria to those lower-level nodes 404, which continue the forwarding process until the point-of separation nodes 404 are reached. This is shown in FIG. 10B, in which node 404-3 forwards the search criteria from master node 402 to lower-level nodes 404-4 and 404-5. In either event, when a leaf node 404 receives a search request, it performs the indicated search.
3. Each unique node 404 with positive search results replies to the point of integration 402, as shown by arrows 1006 in FIGS. 10A and 10B (step 1106). If particular node 404 has a higher-level node 404 that is not the master node 402, that higher-level node 404 continues to forward the results up the hierarchical tree until the master node 402 is reached. This is likewise shown in FIG. 10B, in which the higher-level node 404-3 forwards the search results from lower-level nodes 404-4 and 404-5 to the master node 402.
4. The master node 402 compiles the collected search results and provides them to its presentation layer 602, which prepares the results and transmits them to the user for display them in the user's browser (step 1108). The browser displays the search results in a fashion similar to how it does today in an Eclipse implementation. However, instead of displaying a list of topics or subtopics containing search hits, the browser displays a list of nodes 404 reporting positive search results.
5. When the user selects a particular node 404 from the list of nodes reporting search results (step 1110), the master node 402 launches a new browser window of results for the selected node 404 (FIG. 13) (step 1112), with the results for that node being displayed in a manner similar to the manner in which they are displayed today in a conventional system.

This implementation supports the search function of a virtual information center, by utilizing the same search that exists today, while utilizing the point of integration to present the virtual results.

The present invention allows an extremely large amount of information to be presented in one information center, even though it is not actually hosted in any one information center. The points of separation are really their own information centers, while the point of integration creates one virtual information center. The current limitations of the Eclipse-based WebSphere help system information centers are such that multiple information sets cannot be comfortable hosted in one information center at a time, due to size constraints, ease-of-use issues, and update problems. This invention will alleviate that current constraint.

While particular implementations have been shown and described, various modifications will be apparent to those skilled in the art.

What is claimed is:

1. A method of providing a searchable virtual information center comprising the steps of:
providing a master node accessible by a user and a plurality of information nodes coupled to said master node containing searchable documentation;
receiving at said master node a search request from a user containing search criteria for searching said documentation;
transmitting said search request from said master node to said information nodes;
receiving results of said search request from said information nodes at said master node; and
presenting the results of said search request to said user from said master node.

2. The method of claim 1 in which one or more of said information nodes are intermediate nodes having one or more lower-level nodes, each of said intermediate nodes, upon receiving a search request from a higher-level node, transmitting the search request to its lower-level nodes.

3. The method of claim 2 in which each of said intermediate nodes, upon receiving results of a search request from a lower-level node, transmits the results to a higher-level node.

4. The method of claim 1 in which said presenting step comprises the step of:
displaying a list of information nodes reporting search results.

5. The method of claim 4, further comprising the steps of:
receiving input from said user selecting an information node from said list; and
in response to receiving said input, displaying the search results reported by said node.

6. A system for providing a searchable virtual information center comprising:
a master node accessible by a user and a plurality of information nodes coupled to said master node containing searchable documentation;
means for receiving at said master node a search request from a user containing search criteria for searching said documentation;
means for transmitting said search request from said master node to said information nodes;
means for receiving results of said search request from said information nodes at said master node; and
means for presenting the results of said search request to said user from said master node.

7. The system of claim 6 in which one or more of said information nodes are intermediate nodes having one or more lower-level nodes, each of said intermediate nodes, upon receiving a search request from a higher-level node, transmitting the search request to its lower-level nodes.

8. The system of claim 7 in which each of said intermediate nodes, upon receiving results of a search request from a lower-level node, transmits the results to a higher-level node.

9. The system of claim 6 in which said presenting means comprises:
means for displaying a list of information nodes reporting search results.

10. The system of claim 9, further comprising:
means for receiving input from said user selecting an information node from said list; and
means responsive to said input for displaying the search results reported by said node.

11. A program storage device readable by a machine, tangibly embodying a program of instructions executable by the machine to perform method steps for providing a searchable virtual information center, said method steps comprising:
providing a master node accessible by a user and a plurality of information nodes coupled to said master node containing searchable documentation;
receiving at said master node a search request from a user containing search criteria for searching said documentation;
transmitting said search request from said master node to said information nodes;
receiving results of said search request from said information nodes at said master node; and
presenting the results of said search request to said user from said master node.

12. The program storage device of claim 11 in which one or more of said information nodes are intermediate nodes having one or more lower-level nodes, each of said intermediate nodes, upon receiving a search request from a higher-level node, transmitting the search request to its lower-level nodes.

13. The program storage device of claim 12 in which each of said intermediate nodes, upon receiving results of a search request from a lower-level node, transmits the results to a higher-level node.

14. The program storage device of claim 11 in which said presenting step comprises the step displaying a list of information nodes reporting search results.

15. The program storage device of claim 14, said method steps further comprising:
receiving input from said user selecting an information node from said list; and
in response to receiving said input, displaying the search results reported by said node.

16. A method for deploying computing infrastructure for providing a searchable virtual information center, comprising integrating computer-readable code into a computing system, wherein the code in combination with the computing system is capable of performing the following:
providing a master node accessible by a user and a plurality of information nodes coupled to said master node containing searchable documentation;
receiving at said master node a search request from a user containing search criteria for searching said documentation;
transmitting said search request from said master node to said information nodes;
receiving results of said search request from said information nodes at said master node; and
presenting the results of said search request to said user from said master node.

17. The method of claim 16 in which one or more of said information nodes are intermediate nodes having one or more lower-level nodes, each of said intermediate nodes, upon receiving a search request from a higher-level node, transmitting the search request to its lower-level nodes.

18. The method of claim 17 in which each of said intermediate nodes, upon receiving results of a search request from a lower-level node, transmits the results to a higher-level node.

19. The method of claim 16 in which said presenting step comprises the step of:
displaying a list of information nodes reporting search results.

20. The method of claim 19, wherein the code in combination with the computing system is further capable of performing the following:
receiving input from said user selecting an information node from said list; and
in response to receiving said input, displaying the search results reported by said node.
